(19) United States
(12) Patent Application Publication
(10) Pub. No.: US 2010/0158650 A1
(43) Pub. Date: Jun. 24, 2010

(54) Silo with reciprocating frame having beveled inner surfaces

(75) Inventors: Franz Tillman, Lagrangeville, NY (US); Charles Wanstrom, Maplewood, MN (US); Thomas M. Anderson, Naples, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Schwing Bioset, Inc., Somerset, WI (US)

(21) Appl. No.: 12/317,413

(22) Filed: Dec. 22, 2008

(51) Int. Cl. B65G 65/30

(52) U.S. Cl. 414/306; 414/808

(57) ABSTRACT

A reciprocating frame for a silo has outside bevels located on outer surfaces of a rim. Outside bevels slide under material as the reciprocating frame moves across a silo floor. The reciprocating frame has inside bevels located on inner surfaces of the rim. The inside bevels contact material at an angle that provides downward force to the reciprocating frame as it moves across the silo floor.

### BACKGROUND

The present invention relates generally to a method and a device for discharging material from a silo. More specifically, the present invention relates to a silo having a reciprocating frame.

Silos are large receptacles used to store and discharge materials. Silos usually have an inlet at the top and an outlet at the bottom. Virtually any type of material may be placed into a silo and later discharged. Viscous wet materials, however, are difficult to discharge because they are not free-flowing. For example, municipal waste sludge stored in silos tends to clump together and form bridges over a discharge opening. Discharge devices may be incorporated into the bottom of a silo above a discharge opening to dislodge material bridges and induce sludge flow.

Several types of discharge devices for coaxing sludge out of silos are known. In rectangular and square silos, the push floor design is common. The push floor consists of a series of hydraulically driven ladders that move linearly to convey sludge toward a discharge opening. In circular or polygonal silos, rotating scrapers or movable frames may be incorporated near the silo floor. In the case of rotating scrapers, radial arms extending from a central body include rotating or oscillating scrapers that break up clumps of sludge. In the case of movable frames, an open frame structure reciprocates back and forth over the silo floor pushing and pulling sludge along with it and over a discharge opening. While inclusion of a discharge device near the floor of a silo is known, the construction and operation of such discharge devices are far from ideal.

### SUMMARY

An exemplary embodiment of the present invention is a reciprocating frame for a silo having at least one rim. The rim has an outer rim surface and an inner rim surface. Outside bevels are located on the outer rim surface and slide under material as the frame moves across a silo floor. Inside bevels are located on the inner rim and contact material at an angle that provides downward force to the frame as the frame moves across the silo floor.

Another exemplary embodiment of the present invention is a method of agitating material in a silo. The method includes moving a reciprocating frame in a first direction so that an outside bevel located on an outer rim surface slides under material in a silo and moving the reciprocating frame in a second direction so that a inside bevel located on an inner rim surface contacts material at an angle that provides downward force to the reciprocating frame.

### BRIEF DESCRIPTION OF THE DRAWINGS

FIG. 1 is a perspective view of a silo having a reciprocating frame.

FIG. 2 is a top view of the inside of the silo from FIG. 1 with the reciprocating frame in a first, fully retracted position.

FIG. 3 is a top view of the inside of the silo with the reciprocating frame in a second, fully extended position.

FIG. 4 is a detailed top view of the reciprocating frame.

FIG. 5A is an elevated side view and FIG. 5B is an elevated front view of the reciprocating frame from FIG. 4.

FIG. 6 is a cross-section of a rim of the reciprocating frame from FIG. 4.

FIG. 7 is a top view of an alternative embodiment of a silo having a plurality of reciprocating frames.

FIG. 8 is an elevated side view of a reciprocating frame from FIG. 7.

### DETAILED DESCRIPTION

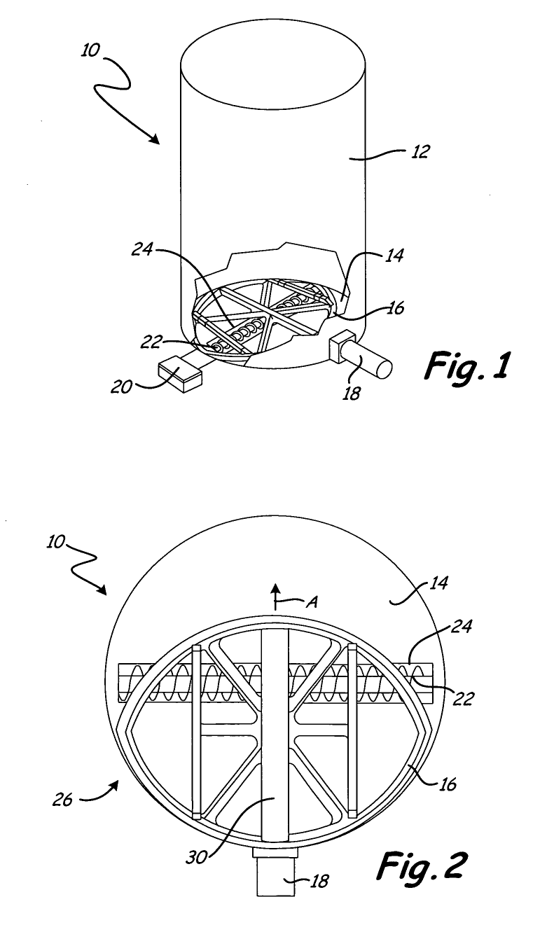

FIG. 1 is a perspective view of silo 10 with a portion of exterior wall 12 broken away to expose floor 14 and reciprocating frame 16. Also visible are hydraulic system 18, outlet 20, screw conveyor 22, and opening 24.

Silo 10 has exterior wall 12 attached to floor 14. Exterior wall 12 is an upstanding cylinder resting on top of circular floor 14. Reciprocating frame 16 is located within silo 10 immediately above and parallel to floor 14. Reciprocating frame 16 is an open structure attached to hydraulic system 18, which extends beyond exterior wall 12. Outlet 20 is also exterior to exterior wall 12 and is connected to screw conveyor 22. Screw conveyor is located beneath opening 24 in floor 14. Opening 24 is an elongated rectangle extending substantially across a diameter of circular floor 14.

Material is generally stored within silo 10 to be discharged at a later time. Usually, material is placed into silo 10 through an opening in a top of silo 10, although other configurations are known. Gravity causes material placed in silo 10 to accumulate near floor 14. All sorts of materials may be stored in silo 10, including dry materials, wet materials, or sludge-like combinations of wet and dry materials. When the material is highly viscous, it tends to resist natural gravitational flow. In at least this instance, it is desirable to include at least one reciprocating frame 16 near floor 14 to mechanically induce flow in the viscous material. Reciprocating frame 16 is attached to hydraulic system 18, which actuates reciprocating frame 16 across floor 14. The resulting back and forth movement of reciprocating frame 16 breaks up cohesive masses while pushing and pulling the material toward opening 24. Beneath opening 24 in floor 14 is at least one screw conveyor 22. Material falls through opening 24 and onto screw conveyor 22, which may include a rotating screw and/or a means for metering material. Screw conveyor 22 then discharges material from silo 10 via outlet 20. Discharged material may be picked up and transported to another location.

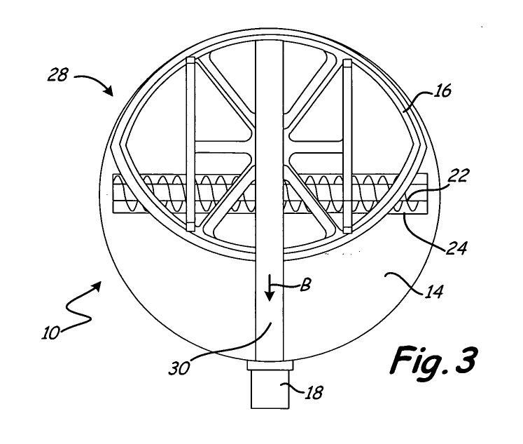

FIGS. 2 and 3 depict the movement of reciprocating frame 16 across floor 14. FIG. 2 is a top view of the inside of silo 10 with reciprocating frame 16 in first, fully retracted position 26. FIG. 3 is a top view of the inside of silo 10 with reciprocating frame 16 in second, fully extended position 28. Also visible in FIGS. 2 and 3 are hydraulic system 18, screw conveyor 22, opening 24, and pushrod 30.

Reciprocating frame 16 is connected to hydraulic system 18 via pushrod 30. At rest, reciprocating frame 16 is in first position 26 as depicted in FIG. 2. Once activated, hydraulic system 18 drives pushrod 30 further into silo 10, which actuates reciprocating frame 16 across floor 14 in direction A. Reciprocating frame 16 leaves first position 26 pushing and pulling material toward opening 24, encouraging material to fall through opening 24 onto screw conveyor 22. Reciprocating frame 16 will continue across floor 14 in direction A until pushrod 30 reaches full extension, or until an obstruction prevents further movement.

If no obstruction is encountered and hydraulic system 18 remains activated, reciprocating frame 16 will reach second position 28 on an opposite end of silo 10, which is depicted in FIG. 3. Reciprocating frame 16 will move across floor 14 once between occupying first position 26 and occupying second position 28. In second position 28, reciprocating frame 16 is remote from hydraulic system 18 and pushrod 30 is fully extended. Pushrod 30 is capable of retracting back toward hydraulic system 18 and actuating reciprocating frame 16 back across floor 14 in direction B. Reciprocating frame 16 leaves second position 28 pushing and pulling material toward opening 24, once again encouraging material to fall through opening 24 onto screw conveyor 22. If no obstruction is encountered and hydraulic system 18 remains activated, pushrod 30 will retract until reciprocating frame 16 has returned to first position 26. The resulting movement of reciprocating frame 16 between first position 26 and second position 28 agitates viscous material and coaxes the material to fall through opening 24 onto screw conveyor 22 for discharge from silo 10.

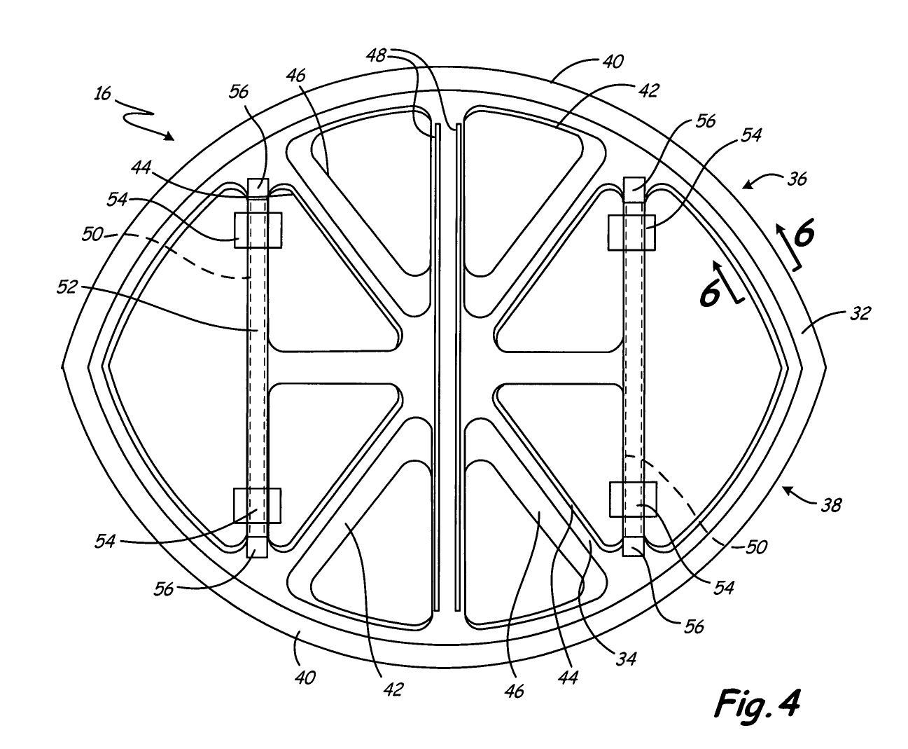

FIG. 4 is a detailed top view of reciprocating frame 16 including rim 32, center scraper 34, first half 36, and second half 38. Rim 32 has outer rim surface 40 and inner rim surface 42. Center scraper 34 has inner scraper surface 44 and outer scraper surface 46. Also visible are bars 48, support members 50, tubes 52, hold-down plates 54, and tube ends 56.

Reciprocating frame 16 has at least one rim 32. In the depicted embodiment, rim 32 is elliptical and contains center scraper 34, which is shaped like the letter “X” and extends across a minor axis of rim 32. The shape of rim 32 and center scraper 34 is dependant on a multitude of factors including the silo size, the location of an opening in the floor, and the type of materials to be stored in the silo. In an alternative embodiment, rim 32 is rectangular and does not contain a center scraper. Thus, rim 32 is capable of assuming alternate shapes while achieving the objectives outlined below.

In the depicted embodiment, center scraper 34 extends across a y-axis of rim 32 so that first half 36 of center scraper 34 is attached to first half 36 of rim 32, and second half 38 of center scraper 34 is attached to second half 38 of rim 32. Rim 32 has outer rim surface 40 facing outward and inner rim surface 42 facing inward toward center scraper 34. Center scraper 34 has inner scraper surface 44 facing an x-axis of rim 32 and outer scraper surface 46 facing the y-axis of rim 32. Outer rim surface 40 and inner rim surface 42, as well as inner scraper surface 44 and outer scraper surface 46, are beveled to reduce friction between reciprocating frame 16 and material within a silo. In one embodiment, the bevels on outer rim surface 40 and outer scraper surface 46 are of a smaller angle than the bevels on inner rim surface 42 and inner scraper surface 44. The bevels on outer rim surface 40 and outer scraper surface 46 are similar and form angles between approximately 1 and 45 degrees, although any acute angle is within the scope of the present invention. The bevels on inner rim surface 42 and inner scraper surface 44 are similar and form angles between approximately 45 and less than 90 degrees, although any acute angle is within the scope of the present invention. The beveled surfaces of reciprocating frame 16 may be machined from a metal, such as carbon steel, or the bevels may be a composite including a filler material in order to reduce manufacturing cost and/or friction between the bevels and material within a silo.

Bars 48 extend substantially across a y-axis of rim 32 and are centrally located within both rim 32 and center scraper 34. First half 36 of bars 48 extend to toward inner rim surface 42 of first half 36 of rim 32. Second half 38 of bars 48 extend toward inner rim surface 42 of second half 38 of rim 32. In one embodiment, there are two bars 48, although more or less bars 48 are contemplated. A plurality of support members 50 are also located within rim 32. Support members 50 run parallel to bars 48 and also extend substantially across the y-axis of rim 32, but are located on either side of center scraper 34. First half 36 of support members, 50 extend toward inner rim surface 42 of first half 36 of rim 32, and second half 38 of support members 50 extend toward inner rim surface 42 of second half 38 of rim 32. Tubes 52 are located on top of, run the length of, and attach to, support members 50. Tubes 52 are rectangular and have closed, beveled tube ends 56 to reduce friction between tubes 52 and material within a silo. Tubes 52 may extend through, and be surrounded by, one or more hold-down plates 54. Each hold-down plate 54 is shaped like an upside down letter “U”, which is capable of surrounding a tube 52 and attaching to a floor of a silo to prevent the reciprocating frame from drifting.

As described above with reference to FIGS. 2 and 3, reciprocating frame 16 is capable of bi-directional movement across a floor of a silo. When reciprocating frame 16 moves it comes into contact with material and experiences resistance. Outer rim surface 40 and outer scraper surface 46 are beveled so that they slide under material as reciprocating frame 16 moves across a silo floor. Inner rim surface 42 and inner scraper surface 44 are beveled to contact material at an angle that produces downward force to reciprocating frame 16. Bars 48 are configured to attach reciprocating frame 16 to a pushrod of a hydraulic system that actuates reciprocating frame 16 across a silo floor. Support members 50 are configured to help maintain the shape of reciprocating frame 16, as well as support tubes 52. Tubes 52 are configured to cooperate with hold-down plates 54 to keep reciprocating frame 16 from floating upwards or over to one side of a silo. As reciprocating frame 16 moves from a first position to a second position, tubes 52 slide through one or more hold-down plates 54 thereby keeping reciprocating frame 16 adjacent a silo floor. Beveled inner rim surface 42 and beveled inner scraper surface 44, as well as the tubes 52 cooperating with hold-down plates 54, aim to keep reciprocating frame 16 in its intended location.

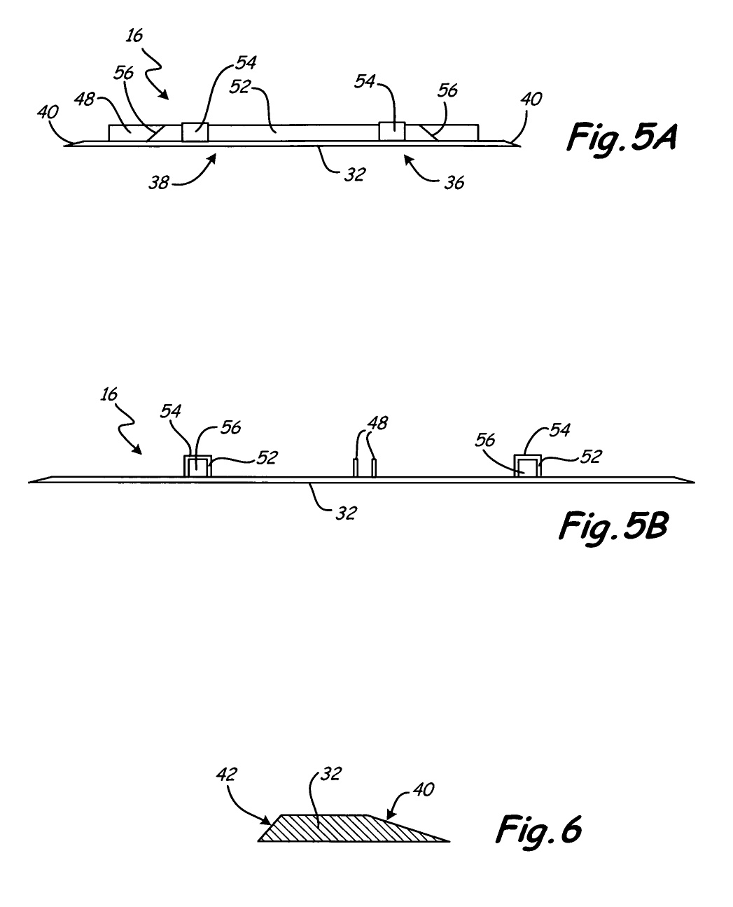

FIG. 5A is a side elevation and FIG. 5B is a front elevation of reciprocating frame 16 showing rim 32, first half 36, second half 38, outer rim surface 40, bars 48, tubes 52, hold-down plates 54, and tube ends 56. Reciprocating frame 16 has rim 32, first half 36, and second half 38. Rim 32 has beveled outer rim surface 40. Bars 48 are centrally located within rim 32 and extend upwards to attach to a push-rod. Tubes 52 are located on either side of bars 48 and also extend upwards to cooperate with hold-down plates 54. Hold-down plates 54 extend around tubes 52 and attach to a floor of a silo beneath reciprocating frame 16 to hold the reciprocating frame 16 in place. In one embodiment, tube ends 56 are closed and beveled to reduce friction between tubes 52 and material within a silo.

FIG. 6 is a cross-section of rim 32 of reciprocating frame 16 taken on line 6 of FIG. 4. Rim 32 has outer rim surface 40 and inner rim surface 42. Both outer rim surface 40 and inner rim surface 42 are beveled. In one embodiment, the angle formed by inner rim surface 42 is greater than the angle formed by outer rim surface 40. Outer rim surface 40 is beveled to produce an angle of approximately 1 to 45 degrees and inner rim surface 42 is beveled to produce an angle of approximately 45 to less than 90 degrees. Outer rim surface 40 is beveled to slide under material and reduce the amount of friction between rim 32 and material within a silo. Inner rim surface 42 is beveled to contact material at an angle that provides downward force to rim 32 as reciprocating frame 16 moves across a floor of a silo.

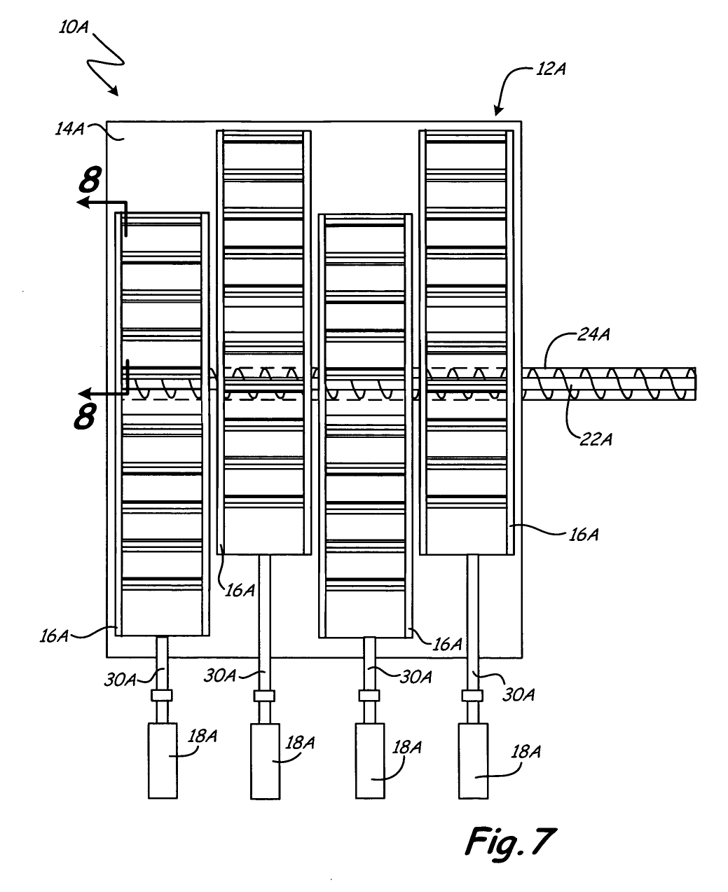

FIG. 7 is a top view of an alternative embodiment of silo 10A having a plurality of reciprocating frames 16A. Illustrated in FIG. 7 are silo 10A, exterior wall 12A, floor 14A, reciprocating frames 16A, hydraulic cylinders 18A, screw conveyor 22A, opening 24A and push-rods 28A. The components of silo 10A are substantially similar to the components of silo 10 described above. The discussion below focuses on the differences between silo 10 and silo 10A, namely, the number and shape of reciprocating frames 16A.

Silo 10A is defined by upstanding exterior wall 12A resting on top of rectangular floor 14A. In the depicted embodiment, four reciprocating frames 16A are located immediately above and parallel to floor 14A, although more or less reciprocating frames 16A are equally possible. Reciprocating frames 16A are attached to, and actuated by, hydraulic cylinders 18A. Screw conveyor 22A is located beneath opening 24A in floor 14A. In the depicted embodiment, opening 24A and screw conveyor 22A are all centrally located, although they can be offset to one side or another. Connecting reciprocating frames 16A to hydraulic cylinders 18A are push-rods 28A.

Reciprocating frames 16A operate in much the same manner as reciprocating frame 16 described above. Hydraulic cylinders 18A extend and retract push-rods 28A, which actuate reciprocating frames 16A across floor 14A. As pushrods 28A extend further into silo 10A, reciprocating frames 16A are moved to a position remote from hydraulic cylinders 18A. As pushrods 28A retract back out of silo 10A, reciprocating frames 16A are moved to a position adjacent hydraulic cylinders 18A. In the depicted embodiment, reciprocating frames 16A are staggered so that as one moves away from hydraulic cylinder 18A the neighboring reciprocating frame 16A is moves closer to hydraulic cylinder 18A. When reciprocating frames 16A move across floor 14A, material within silo 10A is pushed and pulled toward opening 24A such that it can fall through opening 24A onto screw conveyor 22A.

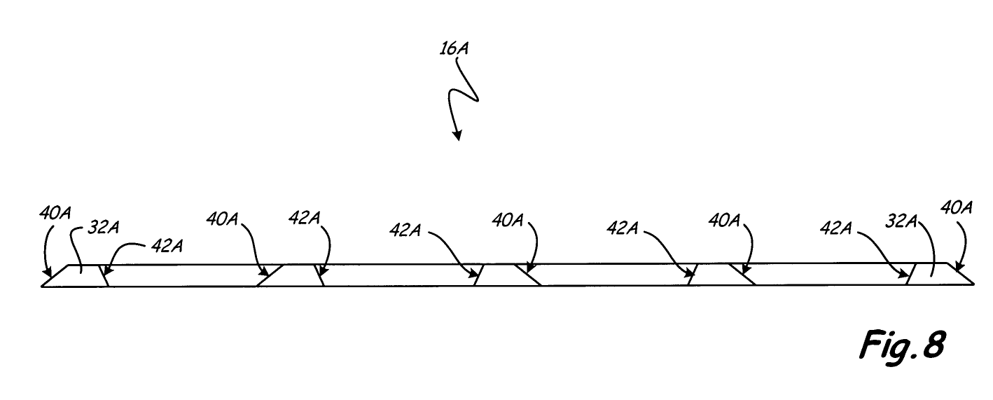

FIG. 8 is a side view of reciprocating frame 16A taken on line 8-8 of FIG. 7. Illustrated in FIG. 8 are reciprocating frame 16A, rims 32A, outside bevels 40A, and inside bevels 42A. Reciprocating frame 16A and its components function similarly to reciprocating frame 16 described above. The discussion below will focus on the features of reciprocating frame 16A that differ from reciprocating frame 16. Namely, the number and shape of rims 32A.

In the depicted embodiment, each reciprocating frame 16A includes a plurality of rims 32A. Rims 32A are repeated at regular intervals along reciprocating frame 16A such that they appear like rungs on a ladder. Each rim 32A has outer rim surface 40A facing outward and inner rim surface 42A facing inward. Outer rim surface 40A and inner rim surface 42A are beveled to reduce friction between reciprocating frame 16A and material within a silo. The bevels on outer rim surface 40A are of a smaller angle than the bevels on inner rim surface 42A. A cross-section of rim 32A would be identical to the cross section of rim 32 depicted in FIG. 6. As was the case with rim 32, the bevels on outer rim surface 40A form angles between approximately 1 and 45 degrees, although any acute angle is within the scope of the present invention. Similarly, the bevels on inner rim surface 42A form angles between approximately 45 and less than 90 degrees, although any acute angle is within the scope of the present invention. The beveled surfaces of reciprocating frame 16A may be machined from a metal, such as carbon steel, or the bevels may be a composite including a filler material in order to reduce manufacturing cost and/or friction between the bevels and material within a silo.

When reciprocating frame 16A moves, rim 32A comes into contact with material and experiences resistance. Outer rim surface 40A is beveled so that it more easily slides under material as reciprocating frame 16A moves across a silo floor. Beveling of outer rim surface 40A reduces friction between rim 32A and material within a silo. Inner rim surface 42A is beveled to contact silo material at an angle that produces downward force to reciprocating frame 16A. Beveling inner rim surface 42A keeps reciprocating frame 16A adjacent a silo floor in its intended location.

Although the present invention has been described with reference to preferred embodiments, workers skilled in the art will recognize that changes may be made in form and detail without departing from the spirit and scope of the invention.

1. A reciprocating frame for a silo, the reciprocating frame comprising:
at least one rim having an outer rim surface and an inner rim surface;
outside bevels located on the outer rim surface for sliding under material as the frame moves across a silo floor; and
inside bevels located on the inner rim surface for contacting material at an angle that provides downward force to the frame as the frame moves across the silo floor.

2. The reciprocating frame of claim 1, wherein the inside bevels form angles greater than the outside bevels.

3. The reciprocating frame of claim 2, wherein the outside bevels form angles between approximately 1 and approximately 45 degrees.

4. The reciprocating frame of claim 3, wherein the inside bevels form angles between approximately 45 and less than 90 degrees.

5. The reciprocating frame of claim 1, wherein the outside bevels comprise metal.

6. The reciprocating frame of claim 5, wherein the inside bevels comprise metal.

7. The reciprocating frame of claim 6, wherein the outside and inside bevels comprise carbon steel.

8. The reciprocating frame of claim 1, wherein the outside bevels are composite and include filler.

9. The reciprocating frame of claim 8, wherein the inside bevels are composite and include filler.

10. The reciprocating frame of claim 1, wherein the at least one rim is a plurality of rims repeated at a regular interval.

11. The reciprocating frame of claim 1 further comprising:
a center scraper extending across an interior of the rim, the center scraper having an outer scraper surface and an inner scraper surface;
outside bevels located on the outer scraper surface for sliding under material as the frame moves across a silo floor; and
inside bevels located on the inner scraper surface for contacting material at an angle that provides downward force to the frame as the frame moves across the silo floor.

12. The reciprocating frame 11, wherein the rim is approximately elliptical.

13. The reciprocating frame of claim 12, wherein the center scraper is approximately X-shaped.

14. The reciprocating frame of claim 11, further comprising:
support members extending across the interior of the rim on either side of the center scraper.

15. A method of agitating material in a silo, the method comprising:
moving a reciprocating frame in a first direction so that an outside bevel located on an outer rim surface slides under material in a silo; and
moving the reciprocating frame in a second direction so that a inside bevel located on an inner rim surface contacts material at an angle that provides downward force to the reciprocating frame.

16. The method of claim 15, wherein moving a reciprocating frame in a first direction includes engaging an outside bevel located on an outer scraper surface, which also slides under material in a silo.

17. The method of claim 16, wherein moving a reciprocating frame in a second direction includes engaging an inside bevel located on an inner scraper surface, which also contacts material at an angle that provides downward force to the reciprocating frame

18. The method of claim 15, wherein the inside bevel forms an angle greater than the outside bevel.

19. The method of claim 15, wherein the outside bevel forms an angle between approximately 1 and approximately 45 degrees.

20. The method of claim 19, wherein the inside bevel forms an angle between approximately 45 and less than 90 degrees.
